(19) United States
(12) Patent Application Publication
(10) Pub. No.: US 2008/0280126 A1
(43) Pub. Date: Nov. 13, 2008

(54) Open-Celled Foam Having Flam-Retardant and Oleophobic/Hydrophobic Properties and a Process for Producing It

(75) Inventors: Werner Lenz, Ludwigshafen (DE); Horst Baumgartl, Mainz (DE); Bernhard Vath, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/063,946

(22) PCT Filed: Aug. 16, 2006
(86) PCT No.: PCT/EP2006/065343

§ 371 Date: Feb. 15, 2008

(30) Foreign Application Priority Data
Aug. 22, 2005 (DE) 102005039625.9

(51) Int. Cl. B32B 3/26; C08J 9/228

(52) U.S. Cl. 428/319.3; 521/91; 521/85; 521/92; 427/369

(57) ABSTRACT

The invention relates to a foam which comprises a foam matrix having essentially open cells and an impregnation comprising essentially fluorocarbon resin or silicone resin applied to the foam matrix. The impregnation additionally comprises at least one flame-retardant substance. The invention further relates to a process for producing a foam according to the invention.

The invention relates to a foam which comprises a foam matrix having essentially open cells and an impregnation comprising essentially fluorocarbon resin and/or silicone resin applied to the foam matrix, which foam has improved flame-retardant properties. The invention further provides a process for producing such a foam.

Open-celled foams comprising various materials are employed, for example, in thermal or acoustic insulation of buildings and vehicles. Furthermore, open-celled foams are used for the acoustic and thermal insulation of plants and equipment in mechanical engineering.

To prevent the foam from becoming fully soaked with water or oil, DE-A 100 11 388 discloses making a melamine resin foam hydrophobic and oleophobic by coating the foam skeleton with a hydrophobic component, for example a fluoroalkyl ester.

A process by means of which a melamine resin foam can be impregnated is known, for example, from EP-A 0 451 535. For this purpose, a binder is firstly applied to the surface of the melamine resin foam and the foam together with the binder is subsequently passed through a gap between two contrarotating rollers, with the gap between the rollers being set so that it is smaller than the uninfluenced thickness of the melamine resin foam. An additive for producing an oleophobic and/or hydrophobic effect can have been added to the binder. An impregnation which leads to an improvement in the flame-retardant properties is not known from EP-A 0 451 535.

It is an object of the present invention to provide an open-celled foam which has hydrophobic and/or oleophobic properties and additionally displays improved flame-retardant properties.

This object is achieved by a foam which comprises a foam matrix having essentially open cells and an impregnation comprising essentially fluorocarbon resin and/or silicone resin applied to the foam matrix, wherein the impregnation additionally comprises at least one flame-retardant substance.

Suitable foams for the purposes of the present invention are, for example, ones in which the foam matrix is made up of a melamine-formaldehyde polycondensate. Further suitable foams are ones in which the foam matrix is a urea-formaldehyde polycondensate and ones in which the foam matrix is an open-celled polyurethane foam. The foam matrix is preferably made up of a melamine-formaldehyde polycondensate.

In a particularly preferred melamine-formaldehyde polycondensate, the ratio of melamine to formaldehyde for producing the foam matrix is from 1:1.2 to 1:4.

Such melamine-formaldehyde foams are known, for example, from EP-B 0 071 672. The foams are accordingly produced by foaming an aqueous solution of a melamine-formaldehyde condensation product, with the solution comprising an emulsifier, an acid hardener and a blowing agent, preferably a C₅-C₇-hydrocarbon. The melamine-formaldehyde condensate is subsequently cured at elevated temperature.

To give the foam hydrophobic and/or oleophobic properties, it is treated with commercial impregnants comprising fluorocarbon resins or silicone resins. This prevents the foam from becoming fully soaked with liquid water or oil.

In the impregnants, the fluorocarbon and/or silicone resin are preferably present in the form of emulsified droplets in water or volatile organic solvents such as methanol, ethanol, acetone or pentane. Water is preferred as emulsifier because it is nonflammable.

In order to additionally make the foam flame resistant or to improve its flame-retardant properties, it is additionally impregnated with at least one flame-retardant substance.

To save an impregnation step, the foam is preferably impregnated with a mixture of the at least one flame retardant and the fluorocarbon resin and/or silicone resin.

Flame-retardant substances used are generally flame retardants. Flame retardants are chemical compounds which are added to combustible materials to give them better protection against catching fire. Fire retardants minimize the risk of fire being caused by a low-intensity source of ignition, for example a cigarette, candle or an electrical fault. When the flame-retardant material has ignited, the flame retardant retards burning and frequently prevents the spread of the fire to other parts.

The retardation or prevention of the combustion process by flame retardants occurs as a result of chemical or physical action. Chemically acting flame retardants generally interrupt the free-radical chain reaction of combustion in the gas phase or build up a carbonized layer which protects the material from oxygen and forms a barrier against the heat source (intumescence).

The physical action of flame retardants occurs, in particular, by means of cooling as a result of energy-consuming processes triggered by additives and/or a chemical release of water cooling the substrate to a temperature below the temperature necessary for maintaining the combustion process. Finally, the physical action can also occur by means of dilution, in which case inert substances and additives which give off noncombustible gases reduce the oxygen concentration in the combustion gases above the foam to such an extent that combustion is stopped.

Depending on the active element, flame retardants are divided into halogen compounds (bromine and chlorine compounds), phosphorus compounds, nitrogen compounds, intumescent systems, mineral materials (based on aluminum and magnesium) and also borax, Sb₂O₃ and nanocomposites. To improve the flame-retardant properties of plastics, use is made of, for example, aluminum trihydroxide, brominated compounds, chlorinated phosphorus compounds, nonhalogenated phosphorus compounds, chloroparaffins, magnesium dihydroxide, melamines and borates. Suitable flame retardants known to those skilled in the art are described, for example, in the brochure “Flammschutzmittel, häufig gestellte Fragen” of the European Flame Retardants Association, January 2004.

Flame-retardant substances which are suitable for the purposes of the invention are, for example, flame retardants based on silicates, borates, hydroxides and phosphates of metals of main groups I to III, of zinc and of ammonium. The metal of main groups I to III is preferably sodium, potassium, calcium, magnesium or aluminum. The flame-retardant substance is particularly preferably selected from among sodium silicates, potassium silicates, magnesium hydroxide, aluminum hydroxide, sodium borate, potassium borate, magnesium borate, zinc borate and ammonium (poly)phosphates, sodium (poly)phosphates, potassium (poly)phosphates, calcium (poly)phosphates and aluminum (poly)phosphates.

In one embodiment, the impregnation is made up of a mixture comprising the flame-retardant substance and the fluorocarbon resin or silicone resin. For this purpose, the not yet cured fluorocarbon resin or silicone resin, which may, if appropriate, be in the form of an emulsion together with one or more solvents, is firstly mixed with the flame-retardant substance and the foam is subsequently impregnated with this mixture. In addition, at least one polymer dispersion can be present as binder in the mixture. The addition of a binder fixes the flame-retardant substance on the cell struts of the foam and thus prevents liberation of dust in the further processing of the impregnated foam after drying. Preference is given to formaldehyde-free binders, in particular thermally curing acrylate binders as are marketed, for example, by BASF under the trade name Acrodur®. Owing to the thermally curing (crosslinking) properties of these binders, the flame-resistant, hydrophobicized and oleophobicized foam blanks can be shaped as desired in a molding press or a deep-drawing tool. The acoustic properties (sound damping) of the open-celled foam blanks are not impaired by the binder, the hydrophobicizing and oleophobicizing components and the flame-retardant substance but on the contrary are usually even improved. Furthermore, the foam blanks which have been treated in this way can be covered with air-permeable nonwovens made of high-bulk nonwovens or cotton nonwovens and pressed. This form of further processing is employed in particular in the production of sound-absorbing moldings for the automobile industry. To prevent premature curing of the binder, the drying temperatures for the foam blanks must not exceed 100-150° C. The pressing or embossing to produce the molding in the molding press or a deep-drawing tool is carried out at from 150 to 240° C., preferably from 170 to 230° C.

Conventional self-crosslinking dispersions comprise only a small proportion of reactive comonomers; in most cases, these are the formaldehyde-releasing Amol or Mamol monomers. A preferred solution or dispersion of thermally curing acrylate binders, on the other hand, comprises a substantial proportion of acid and alcohol components which crosslink with one another in an esterification reaction on heating. The much higher crosslinking density is responsible for the thermoset character of the thermoformed foam components. Preferred solutions or dispersions of thermally curing acrylate binders do not comprise any constituents which are hazardous to health, so that there are also occupational hygiene advantages compared to binders based on epoxides, phenolic resins and urea-formaldehyde resins. Dispersions of thermally curing acrylate binders, e.g. Acrodur ® dispersions, as binders also have further advantages: the moldings produced therewith have greater elasticity and a partially hydrophobic character compared to moldings produced using solutions of thermally curing acrylate binders, e.g. Acrodur ® solutions.

In a further embodiment, the impregnation is carried out in two stages. In a first stage, the foam matrix is impregnated with the flame-retardant substances and the binder. In a second step, a layer of fluorocarbon resin and/or silicone resin is then applied to the cell struts to hydrophobicize/oleophobicize the foam.

In a preferred embodiment, the foam is impregnated with a mixture comprising fluorocarbon resin or silicone resin, the binder and the flame-retardant substances in a single impregnation step. The mixture generally comprises from 1 to 30% by weight of fluorocarbon resin or silicone resin and from 10 to 70% by weight of flame-retardant substances. The remaining parts by weight consist essentially of binder and water or volatile organic substances. Particular preference is given to mixtures having low contents of fluorocarbon or silicone resins and high contents of flame-retardant substances in order to achieve good fire protection.

The impregnation increases the density of the open-celled foams by from 10 to 2000%. Particular preference is given to density increases in the range from 100 to 1000%. In the case of melamine resin foams having a foam density of about 10 g/l, densities of the impregnated foam in the range from 20 to 100 g/l are particularly preferred.

The foam of the invention, in which the impregnation is made up of a mixture comprising the flame-retardant substance and fluorocarbon resin or silicone resin, is produced by a process comprising the following steps:
(a) mixing of the at least one flame-retardant substance and the resin and optionally the at least one further polymer,
(b) application of the mixture to the foam or soaking of the foam with the mixture,
(c) pressing of the foam together with the mixture in order to introduce the mixture into the pores of the foam,
(d) drying of the foam,
   with the steps (b) and (c) being carried out successively, firstly step (b) then step (c).

The application of the mixture to the foam and the pressing of the foam can be carried out, for example, as described in EP-A 0 451 535. For this purpose, the foam is passed between two rollers rotating in the opposite direction, with the gap between the rollers being selected so that the foam is compressed in each case. The mixture with which the foam is impregnated is fed onto the rollers which are horizontally next to one another, so that a pool of liquid is formed at the point at which the foam passes between the rollers. As a result of the rotational motion of the rollers and the pressing of the foam, the mixture comprised in the pool of liquid is pressed into the foam. The mixture envelops the struts of the foam and thus forms a closed surface after curing.

After application of the mixture and pressing of the foam, the foam which has been impregnated in this way is preferably dried in a drying oven at a temperature in the range from 40 to 200° C.

In order to increase the density of the impregnated foam further, the foam which has been impregnated in a first stage can also pass through the same impregnation process a plurality of times. In this way, the thickness of the layer enveloping the struts, and thus the density, is increased in each step.

In one process variant, the process for producing a foam according to the invention comprises the following steps:
(a) application of the at least one flame-retardant substance to the foam or soaking of the foam with the at least one flame-retardant substance and subsequent pressing or padding to distribute the flame-retardant substance uniformly in the foam,
(b) application of the resin to the foam or soaking of the foam with the resin and
(c) pressing or padding of the foam to distribute the resin uniformly in the foam laden with the at least one flame-retardant substance from step (a).

Apart from application of the substance with which the foam is to be impregnated and subsequent pressing, it is likewise possible to soak the foam with the substance with which it is to be impregnated and subsequently press it. For soaking, the foam is, for example, drawn through a bath comprising the at least one substance with which the foam is to be impregnated. However, any further method which is known to those skilled in the art and by means of which the foam can be soaked is also conceivable.

In a further process variant, it is possible firstly to apply the flame-retardant substances and the binder or soak the foam with this mixture and subsequently press it. In a further impregnation step, the fluorocarbon or silicone resin emulsion is subsequently applied and the foam is pressed again. After the foam has been impregnated with a layer of flame-retardant substances and a layer of oleophobic/hydrophobic substances in this two-stage process, the foam is dried at a temperature in the range from 40 to 200° C.

It is also possible firstly to impregnate the foam with the flame-retardant substances and press it and then to dry the foam before application of the second layer of fluorocarbon or silicone resins.

In both embodiments, pressing is preferably carried out as described in EP-A 0 451 535 by passing the foam through a defined gap between two contrarotating, parallel rollers.

Apart from passing the foam through a gap between two contrarotating rollers, it is also possible to apply the pressure necessary for impregnation by transporting the impregnated foam on a conveyor belt and pressing a roller which rotates at a circumferential velocity which is equal to the velocity at which the foam is being moved onto the foam. Furthermore, the pressure can be applied to the foam by, for example, placing the foam in a press which presses a punch onto the foam. However, continuous pressing is not possible in this case.

Pressing can also be carried out by means of any further apparatus known to those skilled in the art.

The resin with which the foam is impregnated is in both embodiments preferably present as an emulsion in a volatile solvent. Suitable solvents are, for example, water or volatile alcohols such as methanol or ethanol. The resin is particularly preferably present in aqueous emulsion.

It is also possible to produce finished parts which can be classified in the building material class A2 in accordance with DIN 4102 by means of the above-described subsequent impregnation of the open-celled foam. This allows new applications of thermoacoustic components in safety-relevant building sectors in the form of wall or ceiling boards which can be structured and flat, in particular the latter in combination with noncombustible coverings composed of, for example, metal, plasterboard, carbon fiber or fiberglass nonwovens and woven fabrics, etc.

Noncombustible core elements can also be used for fire-resistant door elements, in particular in combination with fire protection boards or strips, e.g. ones composed of Palusol® from BASF AG, which are preferably adhesively joined to a core of the impregnated foam of the invention, where necessary in combination with noncombustible frame constructions which are preferably made of metallic materials or wooden frames.

The foam impregnated by the above process can also make a contribution to an improvement in fire safety as core material for fiberglass or carbon fiber curtains. Such curtains having increased fire safety preferably serve for darkening rooms which are utilized for presentations or demonstrations. With conformity to the burning class A2 in accordance with DIN 4102, such curtains can also make a contribution to fire safety in public buildings, e.g. hospitals, theaters, cinemas, multifunction rooms, etc.

The reduction in the specific smoke toxicity increases the range of possible uses in rail vehicles and in shipbuilding in the form of thermoacoustic insulation of walls, ceilings, air conditions plants and ventilation plants.

### EXAMPLES

### Comparative Example

An unimpregnated melamine-formaldehyde foam is examined in respect of the burning behavior and the behavior in the presence of liquid water. The burning class is determined in accordance with DIN 4102. The burning class is found to be B1. On contact with liquid water, the foam becomes fully soaked and sinks beyond the surface.

### Example

An open-celled melamine-formaldehyde foam is impregnated with a mixture of a 5% strength by weight fluorocarbon resin emulsion and a 30% strength by weight adhesive comprising sodium silicate and is dried at 90° C. The increase in density after drying is 150%. The foam which has been impregnated in this way meets the requirements of burning class A2 in accordance with DIN 4102 and floats on water.

1. A foam which comprises a foam matrix having essentially open cells and an impregnation comprising essentially fluorocarbon resin and/or silicone resin applied to the foam matrix, the impregnation additionally comprising at least one flame-retardant substance, wherein the flame-retardant substance is selected from the group consisting of silicates, borates, hydroxides and phosphates of metals of main groups I to III, of zinc and of ammonium.

2. The foam according to claim 1, wherein the metal of main groups I to III is sodium, potassium, calcium, magnesium or aluminum.

3. The foam according to claim 1, wherein the flame-retardant substance is at least one selected from the group consisting of sodium silicates, potassium silicates, magnesium hydroxide, aluminum hydroxide, sodium borate, potassium borate, magnesium borate, zinc borate, ammonium (poly)phosphate, sodium (poly)phosphates, potassium (poly)phosphates, calcium (poly)phosphates and aluminum (poly)phosphates.

4. The foam according to claim 1, wherein the impregnation is made up of a mixture comprising the flame-retardant substance, the fluorocarbon resin or silicone resin and optionally at least one further polymer.

5. The foam according to claim 1, wherein the impregnation is made up of separate layers, namely a layer comprising the fluorocarbon resin or silicone resin and a layer comprising at least one further polymer together with the flame-retardant substance.

6. The foam according to claim 4, wherein the at least one further polymer is a thermally curing acrylate solution or dispersion.

7. The foam according to claim 6, wherein the foam can be permanently shaped by hot pressing at a temperature in the range from 180 to 240° C.

8. The foam according to claim 1, wherein the foam matrix is made up of a melamine-formaldehyde polycondensate.

9. The foam according to claim 8, wherein the ratio of melamine to formaldehyde for producing the foam matrix is from 1:1.2 to 1:4.

10. The foam according to claim 1, wherein the foam matrix is a urea-formaldehyde foam.

11. The foam according to claim 1, wherein the foam matrix is an open-celled polyurethane foam.

12. A process for producing a foam according to claim 4, which comprises the following steps:
(a) mixing of the at least one flame-retardant substance and the resin and optionally the at least one further binder,
(b) application of the mixture to the foam or soaking of the foam with the mixture and
(c) pressing of the foam together with the mixture in order to introduce the mixture into the pores of the foam,
(d) drying of the foam,
with the steps (b) and (c) being carried out successively, firstly step (b) then step (c).

13. A process for producing a foam according to claim 5, which comprises the following steps:
(a) application of the at least one flame-retardant substance to the foam or soaking of the foam with the at least one flame-retardant substance and subsequent pressing or padding to distribute the flame-retardant substance uniformly in the foam,
(b) application of the resin to the foam or soaking of the foam with the resin and
(c) pressing or padding of the foam to distribute the resin uniformly in the foam laden with the flame-retardant substance from step (a),
with the steps (b) and (c) being able to be carried out simultaneously or successively, firstly step (b) then step (c).

14. The process according to claim 13, wherein the flame-retardant substance is applied first and the resin is then applied to the foam.

15. The process according to claim 14, wherein the foam with the at least one flame-retardant substance applied thereto is firstly pressed before a further impregnation with fluorocarbon resin and/or silicone resin is carried out in a second step.

16. The process according to claim 14, wherein the resin is present as an emulsion in a volatile solvent.

17. (canceled)

18. The foam according to claim 2, wherein the impregnation is made up of separate layers, namely a layer comprising the fluorocarbon resin or silicone resin and a layer comprising at least one further polymer together with the flame-retardant substance.

19. The foam according to claim 3, wherein the impregnation is made up of separate layers, namely a layer comprising the fluorocarbon resin or silicone resin and a layer comprising at least one further polymer together with the flame-retardant substance.

20. (canceled)

21. (canceled)

22. The process according to claim 12, wherein the resin is present as an emulsion in a volatile solvent.

23. The foam according to claim 1 for producing building elements having a thermoacoustic effect used in places having particularly high fire protection requirements.
